(19) United States
(12) Patent Application Publication
(10) Pub. No.: US 2012/0120937 A1
(43) Pub. Date: May 17, 2012

(54) RECEIVING AN IDENTIFIER OF A MOBILE STATION IN A PACKET-SWITCHED WIRELESS NETWORK

(75) Inventors: Anit Lohtia, Plano, TX (US); Alfred Schmidt, Calgary (CA)

(73) Assignee: ROCKSTAR BIDCO, LP, St. Laurent (CA)

(21) Appl. No.: 13/353,853

(22) Filed: Jan. 19, 2012

Related U.S. Application Data
(63) Continuation of application No. 10/913,664, filed on Aug. 6, 2004, now abandoned.

(51) Int. Cl. H04W 92/00; H04L 12/66

(52) U.S. Cl. 370/338

(57) ABSTRACT

A packet-switched wireless communications network includes a radio network controller that receives, from a mobile station, a mobile station identifier over a wireless link. The radio network controller provides packet-switched services without providing circuit-switched services. A session is established, based on the mobile station identifier, between the radio network controller and a packet data service node that provides an interface to a packet-switched network.

### TECHNICAL FIELD

The invention relates generally to receiving an identifier of a mobile station by a radio network controller in a packet-switched wireless network.

### BACKGROUND

Mobile communications systems are made up of a plurality of cells. Each cell provides a radio communications center through which a mobile station establishes a call or other communications session with another mobile station or a terminal connected to either a circuit-switched network (e.g., public-switched telephone network or PSTN) or a packet-switched data network. Each cell includes a radio base station, with each base station coupled to a switching center that controls processing of calls or other communications sessions between or among mobile stations or between mobile stations and terminals connected to a circuit-switched or a packet-switched network.

Various wireless protocols exist for defining communications in a wireless network. One type of protocol is based on the time-division multiple access (TDMA) technology, such as the TIA/EIA-136 standard provided by the Telecommunications Industry Association (TIA) or the Global System for Mobile (GSM) standard. Another type of protocol for wireless communications is based on the code-division multiple access (CDMA) technology. CDMA is a spread spectrum wireless communications protocol in which transmission is based on the spread spectrum modulation technique to allow many users to have access to the same band of carriers.

Traditionally, wireless networks have been designed for carrying circuit-switched voice traffic. However, with the wide availability of the Internet and intranets, packet-switched communications (e.g., web browsing, electronic mail, instant messaging, electronic gaming, and so forth) have become common. As a result, third generation (3G) and beyond wireless technologies are being developed and implemented to provide higher bandwidth and more efficient packet-switched communications (of data as well as voice and other forms of real-time data) over wireless networks.

In the CDMA context, a CDMA 2000 family of standards has been developed that is capable of supporting both traditional circuit-switched wireless communications protocols have also been developed. On the TDMA side, packet-switched wireless communications protocols have also been developed.

The first phase of CDMA 2000 is referred to as 1×RTT (also referred to as 3G1×or 1×), which is designed to increase voice capacity as well as to support data transmission speeds that are faster than typically available. In addition, for even higher data rates, a High Rate Packet Data (HRPD) wireless technology has been developed. HRPD is defined as TIA/EIA/IS-856, “CDMA 2000, High Rate Packet Data Air Interface Specification,” which is adopted by the TIA. The HRPD technology is also referred to as the 1×EV-DO or 1×EV technology. 1×EV-DO provides relatively high data transfer rates over the air interface between mobile stations and base stations.

During initialization or handoff within a 1×RTT wireless network, a pre-assigned IMSI (International Mobile Subscriber Identity) is communicated from the mobile station to the base station controller (BSC). The IMSI from the mobile station is used as a mobile station identifier (MSID) when establishing a packet data session, called an R-P (Radio-Packet) session, between a base station controller and a packet data serving node (PDSN). The PDSN is the interface between the wireless network and a packet-switched network, such as the Internet. An R-P session is a logical connection established over an R-P interface between the RNC 40 and the PDSN 30 for a particular PPP (Point-to-Point Protocol) session.

In a 1×EV-DO wireless network, a 1×EV-DO mobile station (also referred to as an “access terminal”) does not have a pre-assigned IMSI, and thus does not communicate an IMSI to the RNC. Note that the RNC in the 1×EV-DO wireless network is the equivalent of the BSC in the 1×RTT wireless network. When the RNC wants to establish an R-P session between the RNC and PDSN, the RNC needs to provide a MSID to the PDSN to identify the access terminal to the PDSN. Since the access terminal does not send an IMSI to the RNC, some other form of MSID needs to be used over the R-P interface.

Some mobile stations are capable of being operated in both a 1×EV-DO wireless network and a 1×RTT wireless network. To be able to perform a seamless handoff from a 1×EV-DO RNC to a 1×RTT BSC, or vice versa, the MSID of the mobile station in the 1×RTT wireless network and in the 1×EV-DO wireless network should be the same. Conventionally, during handoff from a 1×RTT wireless network to a 1×EV-DO wireless network, the IMSI of the mobile station is assigned by interaction between the 1×EV-DO

RNC and an Access Network Authentication, Authorization, and Accounting (AN-AAA) server. The AN-AAA server performs access terminal authentication. Also, the AN-AAA server returns an IMSI value as part of the authentication to the 1×EV-DO RNC. The RNC then uses this IMSI (assigned by the AN-AAA server) as a MSID to establish an R-P session with a PDSN. The IMSI assigned by the AN-AAA server is the same

IMSI used by the mobile station in the 1×RTT wireless network. Because the IMSI assigned by the AN-AAA server in the 1×EV-DO wireless network is the same as the IMSI assigned in the 1×RTT wireless network, the PDSN is able to detect that the newly established R-P session (between the PDSN and the 1×EV-DO RNC) is the same session as the R-P session between the PDSN and the 1×RTT BSC. In this manner, handoff from the R-P session between the PDSN and the 1×RTT BSC to the R-P session between the PDSN and the 1×EV-DO RNC can successfully occur.

However, if an AN-AAA server is not deployed in a wireless communications network, the 1×EV-DO RNC would be unable to determine the IMSI of the mobile station used in the 1×RTT wireless network. Usually, without an AN-AAA server, the 1×EV-DO RNC assigns, using some proprietary mechanism, an MSID to each 1×EV-DO mobile station during a handoff procedure. The assigned MSID would not match the IMSI used by the mobile station in the 1×RTT wireless network. As a result, an R-P session handoff between the 1×EV-DO RNC and 1×RTT BSC would not be possible, when the AN-AAA server is not present.

### SUMMARY

In general, methods and apparatus are provided to enable communication of a mobile station identifier to a radio network controller in a packet-switched wireless communications network.

In general, according to an alternative embodiment, methods and apparatus enable communication of a mobile station identifier to a radio network controller in a packet-switched wireless communications network without deployment of an Access Network Authentication, Authorization, and Accounting (AN-AAA) server.

Other or alternative features will become more apparent from the following description, from the drawings, and from the claims.

### BRIEF DESCRIPTION OF THE DRAWINGS

FIG. 1 is a block diagram of an example wireless communications network incorporating an embodiment of the invention.

FIGS. 2 and 3 are message flow diagrams of processes for establishing communications in the wireless communications network of FIG. 1, according to some embodiments.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

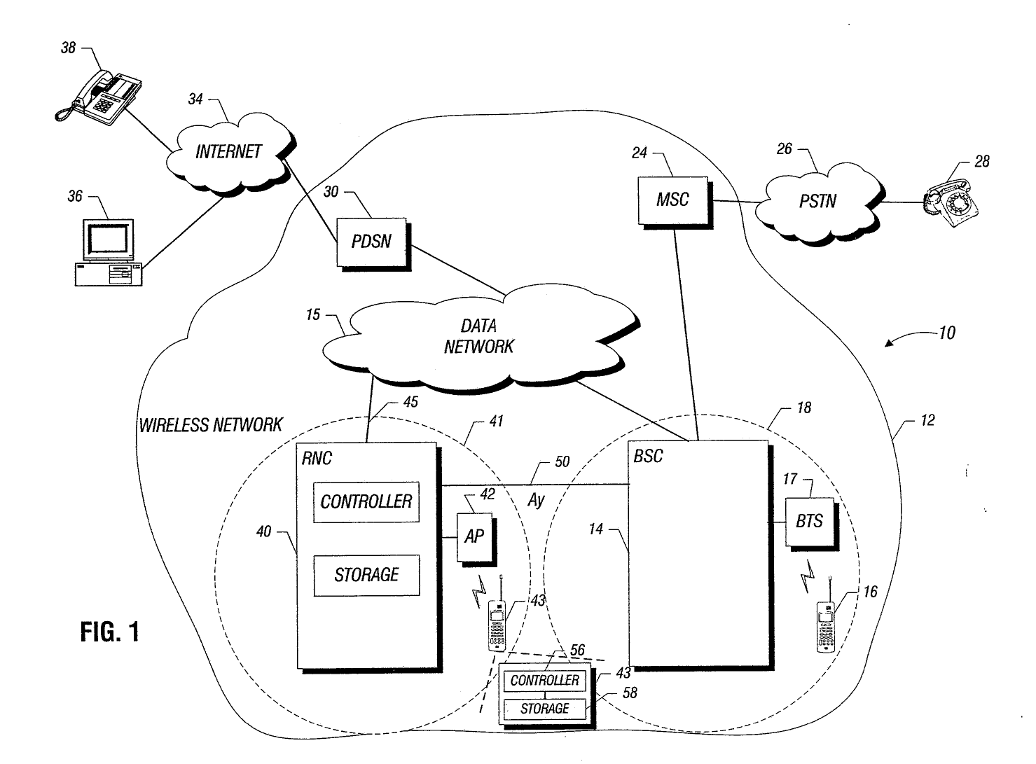

Referring to FIG. 1, a wireless communications network 10 has a coverage area designated generally as 12. In one embodiment, the wireless communications network 10 includes components that operate according to the CDMA (code-division multiple access) 2000 protocol. CDMA 2000 is defined by the CDMA 2000 family of standards (collectively referred to as the IS-2000 Standard, which is developed by the Third Generation Partnership Project 2 (3GPP2)). In other embodiments, other types of wireless protocols, such as TDMA (time-division multiple access) protocols, can be used for communications in the wireless communications network 10.

For circuit-switched communications, the wireless communications network 10 includes a base station controller (BSC) 14 and a base transceiver system (BTS) 17. The BTS 17 is an entity used for radio frequency (RF) telecommunications with mobile stations (e.g., mobile station 16) within a cell or cell sector 18. For communicating circuit-switched voice traffic, the BSC 14 is coupled to a mobile switching center (MSC) 24, which is responsible for switching mobile station-originated or mobile station-terminated traffic. Effectively, the MSC 24 is the interface for signaling and user traffic between the wireless network 10 and other public-switched networks (such as a public-switched telephone network (PSTN) 26 or other MSCs). The PSTN 26 is connected to landline terminals, such as telephone 28.

In addition to circuit-switched services, the BSC 14 can also support packet data communications, in which packet data is communicated between a mobile station and another endpoint, which can be a terminal coupled to a data network 34 or another mobile station that is capable of communicating packet data. Examples of the data network 34 include private networks (such as local area networks or wide area networks) and public networks (such as the Internet). In one example, the BSC 14 is part of a 1×RTT wireless network, which supports packet data services through a packet data serving node (PDSN) 30. The BSC 14 is coupled to the PDSN 30 through a data network 15.

Packet data services involve packet-switched communications. In some embodiments, packet-switched communications are defined by the Internet Protocol (IP). In packet-switched communications, packets or other units of data carry payload (including user data) as well as header information including routing information (in the form of addresses) used for routing the packets or data units over one or more paths of the network to a destination endpoint. One version of IP, referred to as IPv4, is described in Request for Comments (RFC) 791, entitled “Internet Protocol”, dated September 1981; and another version of IP, referred to as IPv6, is described in RFC 2460, entitled “Internet Protocol, Version 6 (IPv6) Specification”, dated December 1998. The data network 15 can be an IP network.

In addition to, or in place of, nodes that are part of a 1×RTT system, the wireless communications network 10 also includes a 1×EV-DO or 1×EV system that supports packet data services. One version of 1×EV-DO is defined in the TIA/EIA/IS-856 standard, entitled “CDMA 2000 High Rate Packet Data Air Interface Specification”. The 1×EV-DO wireless communications system includes an access network (AN) 40, that provides data connectivity between a packet-switched data network (such as the data network 34) and a mobile station 43 (also referred to as an “access terminal”). The access network 40 is connected to an access point 42 (which is the equivalent of the BTS 17 in the 1×RTT wireless network). The access network 40 and access point (AP) 42 provide coverage in a cell or cell sector 41. More generally, reference is made to a “cell segment”, which refers to either a cell or cell sector. Also, “mobile station” generally refers to either a mobile station or an access terminal. Also, the term “radio network controller” or “RNC” refers to a 1×EV-DO RNC, a 1×RTT BSC, or any other type of radio network controller, or base station controller. Although one implementation is described in the context of a 1×EV-DO system, other types of wireless systems can be used in other implementations, such as 1×EV-DV (also referred to as 1×EV-DO Rev. E). More generally, a “1×EV” network or system refers to any of the various versions of the protocols associated with CDMA 2000 that have been evolved to support higher rate packet data transfer.

The access network 40 is coupled to the PDSN 30 through a network 15, such as an R-P transport network, to enable packet-switched communications with the packet-switched data network 34. During a communications session, packet data is routed between the mobile station 43 and another endpoint through the access network 40, R-P transport network 15, and PDSN 30. In addition to the R-P transport network 15 being a packet-switched network (e.g., an IP network), the link between the AP 42 and the RNC 40 can also be a packet-switched network (e.g., an IP network).

Although only one RNC 40 and AP 42 and one BSC 14 and BTS 17 are depicted in FIG. 1, it is noted that the wireless communications network 10 includes multiple RNCs, APs, BSCs, and BTSs.

At least some of the mobile stations in the coverage area 12 of the wireless communications network 10 are capable of communicating with both a 1×RTT BSC 14 and a 1×EV-DO RNC 40. If such a mobile station moves from cell segment 18 to cell segment 41, then a handoff is performed between the BSC 14 and the RNC 40.

Similarly, if a mobile station moves from the cell segment 41 to the cell segment 18, then a handoff occurs from the RNC 40 to the BSC 14.

For each communications session that involves a mobile station, an R-P session is established between the RNC 40 or BSC 14 and the PDSN 30. An R-P session is a logical connection established over an R-P interface between the RNC 40 or BSC 14 and the PDSN 30 for a byte stream between the PDSN and a particular mobile station. The PDSN and mobile station establish a PPP (Point-to-Point Protocol) session over this byte stream. PPP provides a standard method for transporting multi-protocol packets over point-to-point links. Here, the PPP session is to be established between the mobile stations 43, 16 and a PDSN 30. PPP is described in RFC 1661, entitled “The Point-to-Point Protocol (PPP),” dated July 1994.

An R-P session is established based on a mobile station identifier (MSID) that is pre-assigned to the mobile station. One type of MSID is the International Mobile Subscriber Identification (IMSI) that is pre-programmed into a mobile station. The MSID that is pre-assigned to the mobile station is distinct from logical identifiers of users, such as yyyy@nortelnetworks.com. Whereas a logical identifier is typically associated with a user, an MSID is a unique identifier that is pre-assigned to the mobile station. In some embodiments, the MSID is pre-programmed in the mobile station.

To enable proper handoff of an R-P session from the 1×RTT BSC to the 1×EV-DO RNC, or vice versa, in the absence of an Access Network Authentication Authorization and Accounting (AN-AAA) server, a mechanism according to some embodiments enables a mobile station that is capable of communicating in both 1×RTT and 1×EV-DO wireless networks to communicate its pre-assigned MSID to a 1×EV-DO RNC. The ability to communicate the MSID of a mobile station to a 1×EV-DO RNC enables the same MSID to be employed for R-P sessions of the 1×RTT wireless network and 1×EV-DO wireless network. As a result, handoff of an R-P session from a 1×RTT BSC to a 1×EV-DO RNC, and vice versa, can occur without the presence of an AN-AAA server. As discussed above, the presence of an AN-AAA server is needed to enable performance of handoffs between R-P sessions when a mobile station crosses a boundary between a 1×RTT wireless network and a 1×EV-DO wireless network. However, by being able to communicate the MSID of a mobile station to a 1×EV-DO RNC according to some embodiments, the use of an AN-AAA server is not needed. A benefit this offers is that greater flexibility is provided in how the 1×RTT and 1×EV-DO wireless networks are deployed. Also, the ability to avoid having to deploy an AN-AAA server in the wireless networks reduces complexity and cost.

In accordance with some embodiments of the invention, a mobile station that is configured to operate in both a 1×RTT wireless network and a 1×EV-DO wireless network is able to communicate its MSID as part of a network access identifier (NAI) according to a predetermined format. According to one embodiment, the NAI that is communicated from the mobile station to the RNC 40 has the following format: MSID.MSID_TYPE@yyy. Note that this format is in conformance with the logical identifiers that are usually used for the NAI. However, the NM format is changed to incorporate the MSID as being part of the NM. In the example format illustrated above, the MSID forms the first part of the NAI that is communicated from the mobile station to the RNC 40. The NAI also includes a field MSID_{—} TYPE, which identifies the type of MSID that is included in the NAI. The yyy field contains a domain name In one embodiment, the MSID is a numeric string of digits representing an IMSI. In such an implementation, the NM has the following format: <IMSI_VALUE>.IMSI@yyy, where <IMSI_VALUE>is a string of numeric digits representing the value of an IMSI, IMSI is the alphabetic string “IMSI”, and yyy is an alphanumeric string containing a domain name. NAI is described by RFC 2486, entitled “The Network Access Identifier,” dated January 1999.

The pre-assigned MSID in the mobile station, such as mobile station 43 in FIG. 1, is stored in a storage 58. The storage 58 can be a non-volatile memory. The storage 58 is connected to a controller 56 that performs control tasks for the mobile station 43. The RNC 40 also includes a controller 52 and a storage 54. The controller 52 performs the tasks associated with the RNC 40, including the task of deriving the MSID of the mobile station 43 upon receipt of the NM according to the predetermined format. The derived MSID is then used for the purpose of establishing a session with the PDSN 30, such as an R-P session.

Although reference is made to 1×EV-DO and 1×RTT wireless networks in the described embodiments, it is contemplated that other embodiments of the invention can be used in other types of packet-switched wireless networks that support packet-switched services without supporting circuit-switched services. A “packet-switched wireless network” or “packet-switched wireless communications network” refers to a wireless or mobile communications network that is able to provide packet-switched services (e.g., electronic mail, web browsing, electronic gaming, voice-over-IP, etc.). A 1×EV-DO wireless network is an example of a packet-switched wireless network that supports packet-switched services without supporting circuit-switched services. Such a packet-switched wireless network is also referred to as a “packet-switched services only wireless network.” An RNC in a packet-switched services only wireless network is referred to as a “packet-switched services only RNC.” On the other hand, a 1×RTT wireless network is an example of a packet-switched wireless network that supports both packet-switched and circuit-switched services.

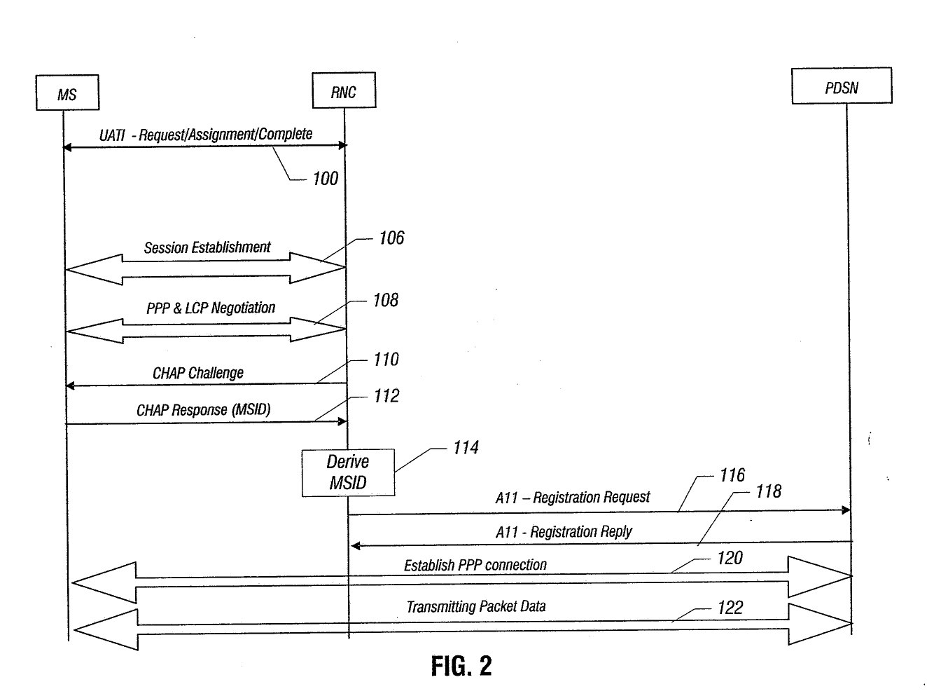

FIG. 2 shows a call flow that illustrates the procedure in response to a mobile station being initialized (e.g., being turned on for the first time) in a 1×EV-DO wireless network. The mobile station and RNC perform (at 100) an exchange of UATI (Unicast Access Terminal Identifier) messages, including a UATI-Request message, a UATI-Assignment message, and a UATI-Complete message. In this procedure, the RNC 40 assigns a unique UATI to the mobile station. After UATI assignment, a 1×EV-DO session is established (at 106) between the mobile station and the RNC. Various session parameters are negotiated during the session establishment procedure. Next, the mobile station and RNC initiate (at 108) PPP and LCP (Link Control Protocol) negotiation for access authentication. LCP, which is part of PPP, is used for establishing, configuring, and testing a data link connection.

Next, as part of the LCP negotiation, the RNC generates and sends (at 110) a CHAP (Challenge Handshake Authentication Protocol) Challenge message to the mobile station. In response, the mobile station sends (at 112) a CHAP response message. CHAP is described in RFC 1994, “PPP Challenge Handshake Authentication Protocol (CHAP),” dated August 1996. In accordance with some embodiments of the invention, the CHAP response sent at 112 contains an NAI that contains the MSID pre-assigned to the mobile station. Based on the NAI, the RNC derives (at 114) the MSID. After deriving the MSID, the RNC sends (at 116) an A11 Registration Request message containing the MSID to the PDSN. The A11 Registration Request message is sent to establish an R-P session (also referred to as an A10 connection) between the RNC and PDSN. The established R-P session is identified by the MSID of the mobile station. The A11 Registration Request message is described in RFC 2002, entitled “IP Mobility Support” dated October 1996.

The PDSN validates the A11 Registration Request message and accepts the connection by returning (at 118) an A11 Registration Reply message with an accept indication to the RNC. Next, a PPP establishment procedure is initiated (at 120) between the mobile station and the PDSN. Once the PPP session has been established, packet data can be communicated (at 122) between the mobile station and the PDSN.

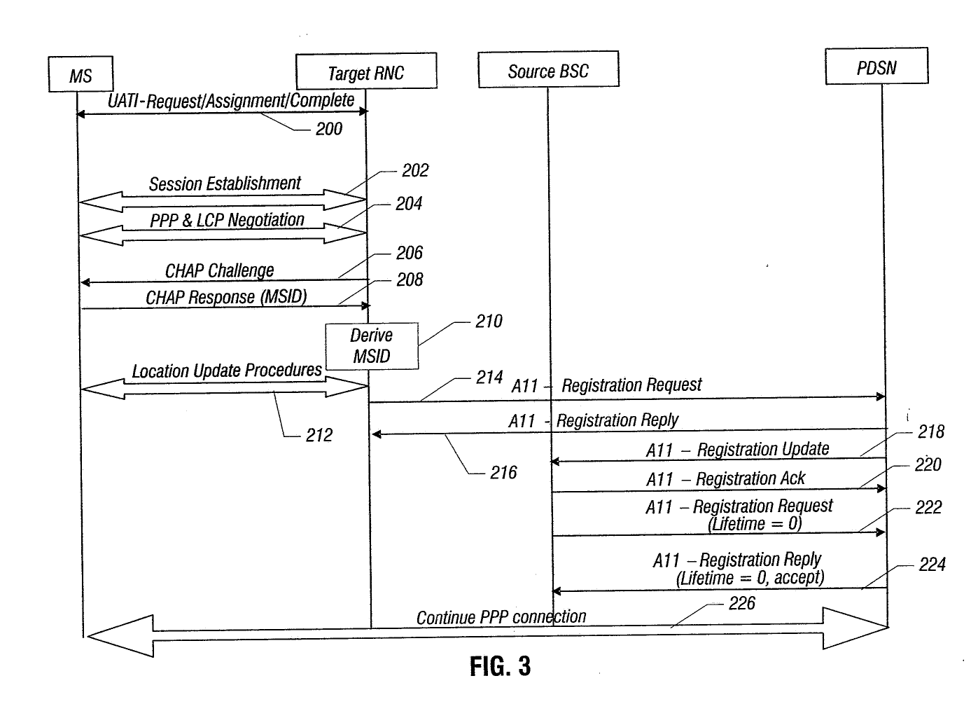

FIG. 3 shows a handoff procedure from a 1×RTT wireless network (that includes a source BSC) to a 1×EV-DO wireless network (that includes a target RNC). The target RNC requests a new R-P session for the mobile station from the PDSN. As discussed above, the R-P sessions are identified by the MSID, such as the IMSI. Acts 200, 202, 204, 206, 208, and 210 depicted in FIG. 3 are the same as acts 100, 106, 108, 110, 112, and 114, respectively, depicted in FIG. 2. The MSID derived at 210 is communicated to the PDSN by the target RNC in an A11 Registration Request message (at 214). The MSID sent by the target RNC is the same as the MSID of the 1×RTT R-P session between the source BSC and the PDSN. When the PDSN receives the request for the new R-P session (in the form of the A11 Registration Request message), the PDSN realizes that an R-P session already exists for the mobile station. As a result, the PDSN clears the old R-P session, and establishes a new R-P session by returning the A11 Registration Reply message (at 216) to the target RNC. The PDSN initiates the termination of the session with the source BSC by sending (at 218) an A11 Registration Update message. The A11 Registration Update message is sent to update the status of the session. The source BSC responds (at 220) with an A11 Registration Ack message. The source BSC then sends (at 222) an A11 Registration Request message with a Lifetime information element set to zero to tear down the R-P session. The PDSN then returns (at 224) an A11 Registration Reply message to the source RNC to close the R-P session for the mobile station, which has been handed off to the target RNC. Note that a new PPP session is not established, but rather, the previous PPP session between the mobile station and the PDSN is continued (at 226).

The tasks performed by the RNC, BSC, and mobile stations are provided by software routines or modules in the RNC, BSC, and mobile stations. Instructions of such software routines or modules are stored on one or more storage devices in the corresponding systems and loaded for execution on corresponding processors. The processors include microprocessors, microcontrollers, processor modules or subsystems (including one or more microprocessors or microcontrollers), or other control or computing devices. As used here, a “controller” refers to hardware, software, or a combination thereof A “controller” can refer to a single component or to plural components (whether software or hardware).

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software are loaded or transported to each entity in one of many different ways. For example, code segments including instructions stored on floppy disks, CD or DVD media, a hard disk, or transported through a network interface card, modem, or other interface device are loaded into the entity and executed as corresponding software routines or modules. In the loading or transport process, data signals that are embodied in carrier waves (transmitted over telephone lines, network lines, wireless links, cables, and the like) communicate the code segments, including instructions, to the entity. Such carrier waves are in the form of electrical, optical, acoustical, electromagnetic, or other types of signals.

While the invention has been disclosed with respect to a limited number of embodiments, those skilled in the art will appreciate numerous modifications and variations there from. It is intended that the appended claims cover such modifications and variations as fall within the true spirit and scope of the invention.

1. A method for use in a packet-switched wireless communications network, comprising:
receiving, at a radio network controller from a mobile station, a unique identifier of the mobile station over a wireless link, wherein the radio network controller provides packet-switched services without providing circuit-switched services; and
establishing a session, based on the unique identifier of the mobile station, between the radio network controller and a packet data service node that provides an interface to a packet-switched network.

2. The method of claim 1, wherein receiving the unique identifier comprises receiving the unique identifier by a 1×EV radio network controller.

3. The method of claim 1, wherein receiving the unique identifier comprises receiving an International Mobile Subscriber Identification (IMSI) by the radio network controller.

4. The method of claim 3, wherein receiving the IMSI comprises receiving the IMSI in a network access identifier.

5. The method of claim 4, wherein receiving the IMSI in a network access identifier comprises receiving the IMSI in a network access identifier having a format MSID.MSID_TYPE@yyy, where MSID contains a numeric string representing an IMSI value, MSID_TYPE is an alphanumeric string that indicates that the MSID is of type IMSI, and yyy is an alphanumeric string that represents a domain name.

6. The method of claim 2, wherein receiving the unique identifier comprises receiving the unique identifier by a 1×EV-DO radio network controller.

7. The method of claim 1, wherein establishing the session comprises sending, from the radio network controller to the packet data service node, an A11 Registration Request message containing the unique identifier.

8. The method of claim 7, wherein the session is an R-P session, and wherein sending the A11 Registration Request message causes establishment of the R-P session between the packet data service node and the radio network controller.

9. The method of claim 2, wherein the 1×EV radio network controller derives the unique identifier based on information from the mobile station rather than based on information from an Access Network Authentication, Authorization, and Accounting (AN-AAA) server.

10. The method of claim 2, wherein the 1×EV radio network controller derives the unique identifier based only on information from the mobile station in the wireless communications network where an Access Network Authentication, Authorization, and Accounting (AN-AAA) server has not been deployed.

11. The method of claim 1, wherein receiving the unique identifier comprises receiving the unique identifier as part of a network access identifier.

12. The method of claim 11, wherein receiving the unique identifier as part of a network access identifier comprises receiving the unique identifier in a network access identifier having a format MSID.MSID_TYPE@yyy, where MSID represents the unique identifier, MSID_TYPE indicates a type of the unique identifier, and yyy represents a domain name.

13. The method of claim 2, wherein receiving the unique identifier occurs in response to a handoff performed from a base station controller to the 1×EV radio network controller.

14. The method of claim 13, wherein receiving the unique identifier occurs in response to the handoff comprises receiving the unique identifier in response to a handoff performed from a 1×RTT base station controller to the 1×EV radio network controller.

15. A system for use in a packet-switched wireless communications network, comprising:
an interface to a wireless link to a mobile station; and
a packet-switched services only controller to:
receive, from the mobile station over the wireless link, a message containing a unique identifier of the mobile station, and
establish a session, based on the unique identifier of the mobile station, with a packet data service node that provides an interface to a packet-switched network.

16. The system of claim 15, wherein the packet-switched services only controller comprises a 1×EV radio network controller.

17. The system of claim 15, wherein the unique identifier comprises an International Mobile Subscriber Identification (IMSI).

18. The system of claim 17, wherein the message contains a network access identifier, the network access identifier containing the IMSI.

19. The system of claim 18, wherein the network access identifier has a format MSID.MSID_TYPE@yyy, where MSID is an alphanumeric string representing an IMSI value, MSID_TYPE is an alphanumeric string that indicates that the MSID is of type IMSI, and yyy is an alphanumeric string that represents a domain name.

20. The system of claim 15, wherein the message comprises a CHAP (Challenge Handshake Authentication Protocol) message, the CHAP message containing the mobile station identifier.

21. An article comprising at least one storage medium containing instructions that when executed cause a radio network controller to:
establish a 1×EV session between the radio network controller and a mobile station; receive a message containing an International Mobile Subscriber Identification (IMSI) from the mobile station over the wireless link for the 1×EV session; and
send a request containing the IMSI to a packet data service node that provides an interface to a packet-switched network, wherein the request is to cause establishment of a session between the radio network controller and the packet data service node.

22. (canceled)

23. The article of claim 21, wherein receiving the message containing the IMSI comprises receiving the message containing a network access identifier, the IMSI being part of the network access identifier.

24. The article of claim 21, wherein the message comprises a CHAP (Challenge Handshake Authentication Protocol) message, the CHAP message containing the IMSI.

25. A mobile station comprising:
an interface to a wireless link to a packet-switched services only radio network controller;
a storage to store an International Mobile Subscriber Identification (IMSI) of the mobile station; and
a controller to send IMSI to the packet-switched services only radio network controller during handoff of the mobile station, wherein sending of the IMSI to the packet-switched services only radio network controller enables the packet-switched services only radio network controller to initiate establishment of a session with a packet data service node based on the IMSI, where the packet data service node is an interface to a packet-switched network.

26. (canceled)

27. The mobile station of claim 25, wherein the controller is to send IMSI to a 1×EV radio network controller.

28. The method of claim 3, wherein receiving the IMSI over the wireless link comprises receiving the IMSI in a message transmitted by the mobile station and destined to the radio network controller.

29. The system of claim 17, wherein the message containing the IMSI is received in response to handoff performed from a base station controller to the packet-switched services only controller.

30. The method of claim 1, wherein establishing the session between the radio network controller and the packet data service node comprises the radio network controller sending a request containing the unique identifier to the packet data service node, wherein the request causes establishment of the session.

31. The system of claim 15, wherein the packet-switched services only controller is configured to establish the session by sending a request containing the unique identifier to the packet data service node.
